(19) United States
(12) Patent Application Publication
(10) Pub. No.: US 2021/0191975 A1
(43) Pub. Date: Jun. 24, 2021

(54) METHODS AND SYSTEMS FOR MANAGING IMAGE COLLECTION

(71) Applicants: Juwei LU, North York (CA); Sayem Mohammad SIAM, North York (CA); Peng DAI, Markham (CA); Wei LI, Markham (CA); Jin TANG, Markham (CA)

(72) Inventors: Juwei LU, North York (CA); Sayem Mohammad SIAM, North York (CA); Peng DAI, Markham (CA); Wei LI, Markham (CA); Jin TANG, Markham (CA)

(21) Appl. No.: 16/722,363

(22) Filed: Dec. 20, 2019

(51) Int. Cl. G06F 16/71; G06F 3/0488; G06F 3/0482; G06F 16/783

(52) U.S. Cl. CPC G06F 16/71; G06F 16/784; G06F 3/0482; G06F 3/04883

(57) ABSTRACT

Methods and systems for managing an image collection. Metadata associated with a captured image includes data identifying each human in the captured image. A linkage score may be generated, representing a relationship between first and second identified humans in the captured image. Records in an image collection database are updated to include the generated linkage score. The linkage information may be used to render a graphical user interface (GUI) for navigating the image collection.

### FIELD

The present application relates generally to methods and system for managing a collection of images, which may include static and/or video images, and, more specifically, to managing the collection of images based on linkages among identified subjects in an image.

### BACKGROUND

Images that have been captured or otherwise generated by a user may be stored and grouped as collections of images (which may be also referred to as “albums”). A collection of images may be a conceptual or virtual grouping of images in one or more image repositories (e.g., image databases or cloud-based storage). That is, images that belong to a given collection are not necessarily grouped together in actual memory storage. In some examples, images from different image repositories may belong to the same image collection.

Various software applications and/or services have been provided for managing images stored in such collections. For example, existing photo/video album applications or services, such as Google™ Photos, are capable of generating an album that includes photographs and videos. The albums are typically organized in a table and cell style view and displayed in a graphical user interface (GUI) on a display device of a computing device (desktop, notebook, tablet, handheld, smartphone, etc.). The photographs and videos may be automatically organized, by the album application, into different groups/subgroups based on location, time, names of people tagged as being in the photograph or video, or some other label associated with each photograph or video. For simplicity, reference to a “captured image” or simply “image” may be understood to be a reference to a photograph (which may also be referred to as a static image) or to a video (which comprises a sequence of images or frames, in which a video frame may also be referred to as an image). Each group/subgroup may be displayed in the GUI in a similar table and cell style view.

### SUMMARY

Through management, in an album application, of human-centric linkages (hereinafter referred to as linkages) based on analysis of captured images (i.e., photos and videos), an album application may be configured to take advantage of the linkages when rendering an album in GUI on a display device. The album application may be shown to facilitate interaction with a collection of captured image to, in one case, allow for efficient searching among the captured documents. Conveniently, the linkages generated from analysis of the collection of captured documents allows for a display of the linkages in a human-centric graphical view.

In the present disclosure, the term “human-centric” means that the analysis of captured images is centered on identifying humans in the images and the linkages (e.g., co-occurrence, visual relationship, or common location) between identified humans. Although the term “human-centric” is used, it should be understood that the approach disclosed herein may also be used for analysis of non-human subjects (e.g., an animal) in captured images.

In some aspects, the present disclosure describes a system including a memory and a processor. The memory includes an image collection database, the image collection database storing a plurality of images. The processor is coupled to the memory, and the processor is configured to execute instructions to cause the system to: receive a set of metadata associated with a captured image, the set of metadata including data identifying each human in the captured image; generate a linkage score associating a first identified human with a second identified human in the captured image, the linkage score representing a relationship between the first and second identified humans; update respective records in the database associated with the first and second identified humans to include the generated linkage score; and store the captured image, in associated with the metadata, in the image collection database.

In some aspects, the present disclosure describes a method of managing an image collection database storing a plurality of images. The method includes: receiving a set of metadata associated with a captured image, the set of metadata including data identifying each human in the captured image; generating a linkage score associating a first identified human with a second identified human in the captured image, the linkage score representing a relationship between the first and second identified humans; updating respective records in the database associated with the first and second identified humans to include the generated linkage score; and storing the captured image, in associated with the metadata, in the image collection database.

In some aspects, the present disclosure describes a computer readable medium storing instructions that, when executed by a processor of a system, cause the system to: receive a set of metadata associated with a captured image, the set of metadata including data identifying each human in the captured image; generate a linkage score associating a first identified human with a second identified human in the captured image, the linkage score representing a relationship between the first and second identified humans; update, in an image collection database storing a plurality of images, respective records associated with the first and second identified humans to include the generated linkage score; and store the captured image, in associated with the metadata, in the image collection database.

In any of the above aspects, the instructions may further cause the system to (or the method may further include): identify each human in the captured image; determine an identifier for each identified human; and generate metadata for inclusion in the set of metadata associated with the captured image, the generated metadata including the identifier for each identified human.

In any of the above aspects, the set of metadata may include metadata identifying a location in the captured image, and the instructions may further cause the system to (or the method may further include): generate an entry describing the first and second identified humans in the identified location; and store the entry in association with the captured image in the image collection database.

In any of the above aspects, the captured image may be a captured video comprising a plurality of video images, and there may be multiple sets of metadata associated with the captured video, each set of metadata being associated with a respective video segment of the captured video. The instructions may further cause the system to (or the method may further include): perform the generating and the updating for each respective video segment.

In any of the above aspects, the captured video may be stored in the image collection database in association with the multiple sets of metadata.

In any of the above aspects, the instructions may further cause the system to (or the method may further include): provide commands to render a graphical user interface (GUI) for accessing the image collection database, the GUI being rendered to provide a visual representation of the relationship between the first and second identified humans.

In any of the above aspects, the instructions may further cause the system to (or the method may further include): in response to input, received via the GUI, indicating a selection of a plurality of humans for filtering the image collection database, identify, from the image collection database, one or more captured images associated with metadata that includes identifiers for each of the plurality of humans; and provide commands to render the GUI to limit access to only the identified one or more captured images.

In any of the above aspects, the input received via the GUI may be a touch input that traverses representations, rendered by the GUI, of the plurality of humans.

Other aspects and features of the present disclosure will become apparent to those of ordinary skill in the art upon review of the following description of specific implementations of the disclosure in conjunction with the accompanying figures.

### BRIEF DESCRIPTION OF THE DRAWINGS

Reference will now be made, by way of example, to the accompanying drawings which show example implementations; and in which:

FIG. 1 illustrates, in a front elevation view, an example electronic device with a display screen;

FIG. 2 illustrates, schematically, elements of the electronic device of FIG. 1,

FIG. 3 illustrates, schematically, an example image collection management system that may be implemented in the electronic device of FIG. 1, in accordance with aspects of the present application, a captured image analysis module;

FIG. 4 illustrates an example of the captured image analysis module of FIG. 3 including, in accordance with aspects of the present application, a static image analysis submodule, a video image analysis submodule and a linkage discovery submodule;

FIG. 5 illustrates an example of the static image analysis submodule of FIG. 4 that, in accordance with aspects of the present application, includes a human detection and recognition submodule that may output a set of metadata to a scene graph recognition submodule;

FIG. 6 illustrates an example of the video image analysis submodule of FIG. 4 in accordance with aspects of the present application;

FIG. 7 illustrates an example of the linkage discovery submodule of FIG. 4 including a linkage analysis submodule and an image collection human knowledge base in accordance with aspects of the present application;

FIG. 8 illustrates example steps in a method of human detection according to an aspect of the present application;

FIG. 9 illustrates an example record among the metadata output by the human detection and recognition submodule of FIG. 5 according to an aspect of the present application;

FIG. 10 illustrates example steps in a method of scene graph recognition according to an aspect of the present application;

FIG. 11 illustrates example steps in a method of image analysis metadata aggregation according to an aspect of the present application;

FIG. 12 illustrates example steps in a method of video segmentation according to aspects of the present application;

FIG. 13 illustrates example steps in a method of human detection, tracking and recognition according to aspects of the present application;

FIG. 14 illustrates example steps in a method of audio analysis according to aspects of the present application according to an aspect of the present application;

FIG. 15 illustrates example steps in a method of human action recognition according to aspects of the present application according to an aspect of the present application;

FIG. 16 illustrates example steps in a method of scene recognition according to aspects of the present application;

FIG. 17 illustrates example steps in a method of video analysis metadata aggregation according to aspects of the present application;

FIG. 18 illustrates examples steps in a method of linkage discovery according to aspects of the present application;

FIG. 19 illustrates an example view of a graphical view that may be presented, according to aspects of the present application, on the display screen of the electronic device of FIG. 1;

FIG. 20 illustrates example steps in a simplified method of presenting the example view of FIG. 19 according to aspects of the present application;

FIG. 21 illustrates example steps in a method of filtering the image collection human knowledge base of FIG. 7 according to aspects of the present application; and

FIG. 22 illustrates an example view of a graphical view that may be presented, according to aspects of the present application, on the display screen of the electronic device of FIG. 1 with an indication of a path for a touch gesture.

### DETAILED DESCRIPTION

Labels for captured images are generally created independently for each captured image. In one instance, one or more labels for a captured image, which may also be called “tags,” can be manually selected by a user and each selected label can be associated with the captured image. In another instance, one or more labels for a captured image may be automatically created and associated with a image by one or more image analysis techniques. Some of these image analysis techniques may use a model, learned using machine learning, to detect objects (including humans and non-humans) in a captured image and classify the detected objects. Existing applications or services for managing image collections (e.g., album applications) may be considered to be appropriate for users to manage a small number, say, in the hundreds, of captured images with a limited number of labels.

Electronic devices, such as smartphones, laptops, tablets, and the like, are becoming popular for capturing images (e.g., capturing static images such as photographs, and recording video images). As the storage capacity of such electronic devices has increased significantly over the years the number of images captured by, and stored on, the average electronic device has increased correspondingly. Indeed, the number of captured images may be seen to have increased to the order of thousands.

To keep the captured images organized, the captured images are generally organized into an image collection using an album application. Notably, as the number of captured images included in an image collection increases, the time spent by users searching for particular captured images in the image collection also increases. Similarly, as the number of captured images included in an image collection increases, the time spent by users organizing the captured images in the image collection can increase significantly.

In addition, as machine learning techniques advance, the number of labels that can be automatically generated and associated, by an image collection application or service, with a captured image has significantly increased. However, such automatically associated labels are generally used independently by the image collection application or service that performs the automatic association. It may be seen as difficult for users to organize and browse their captured images based on such a large number of automatically generated and associated labels.

In overview, aspects of the present application relate to methods and systems for managing an image collection, based on human-centric linkages. An example image collection management system (which may implement machine learning techniques), may be configured to analyze the linkages and use the linkages as a basis for presenting images using a GUI on a display. Such an image collection management system may be shown to facilitate interaction with a collection of captured images to, in one case, allow for more efficient searching among the captured images. Conveniently, the linkages generated from analysis of the collection of captured images may allow for a display of the linkages in a human-centric graphical view.

In contrast to traditional table and cell style views, generated by existing album applications or services, the image collection management system according to aspects of the present application may provide a graphical view of humans detected in the collection of captured images. Images of humans that have been detected in the captured image may be rendered in a GUI by the image collection management system. In some aspects, the images may be linked based human-centric linkages between humans detected in the images. For example, images may be linked based on a co-occurrence of detected humans in the captured images or in a particular common location. A user of the image collection management system can, for example, perform a selection of an image associated, in the graphical view, with a human. When the image collection management system detects a selection of an image associated, in the graphical view, with a human, the image collection management system may rearrange the graphical view to indicate the most related human(s) (e.g., the human(s) having the highest number of linkages, or the most highly scored linkages) to the human associated with the selected image. In some examples, the graphical view may present the most related human(s) limited to a specific time period (e.g., the image collection management system may automatically lessen the scores of the linkages over time, or may prune linkages that are older than a threshold time).

Additionally, a user may select, in the graphical view, multiple individual images associated with related individual humans. When the selection of multiple individual images associated with related individual humans is detected by the image collection management system the image collection management system may rearrange the graphical view to provide indications of captured image in which appear all of the humans associated with the selected images.

Moreover, selection of multiple humans, in the graphical view, can be done with a single gesture. A user may further be provided with an option to specify whether to find all the images that contain all the selected humans or any of the selected humans.

Each linkage between two humans may be described by a sentence template of natural language, e.g., [humans 1] and [humans 2] are attending [event] in [where] in [when]. The natural language sentence may be formulated based on analysis of, for example, recent associated captured images, as discussed further below. In this way, the image collection management system may enable users to more quickly browse a large collection of captured images, discover relationships between humans, learn the activities of the humans in the captured images, and/or more effectively search captured images featuring particular humans of interest.

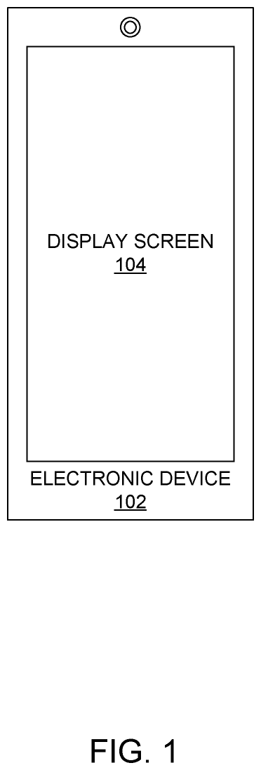

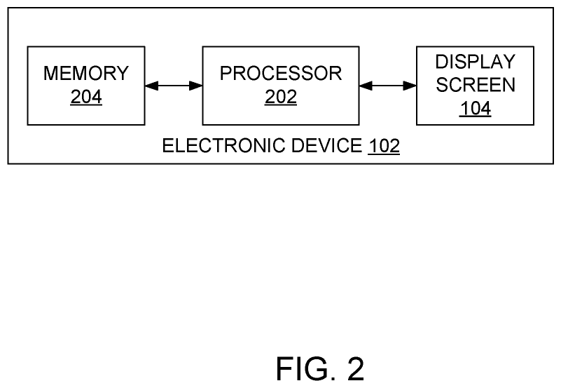

Reference is now made to FIG. 1 and FIG. 2 which respectfully illustrate, in a front elevation view and a schematic block diagram of, an electronic device 102 according to an embodiment of the present disclosure. The electronic device 102 may be, but is not limited to, any suitable electronic device, such as a personal computer, a laptop computer, a smartphone, a tablet, e-reader, personal digital assistant (PDA), and the like. The shape and structure of the electronic device 102 in FIG. 1 is purely for illustrative purposes and the electronic device 102 may have any suitable shape or structure.

The electronic device 102 includes multiple components, including a processor 202 that controls the overall operation of the electronic device 102. The processor 202 is coupled to and interacts with various other components of the electronic device 102, including a memory 204 and a display screen 104, shown in FIG. 1

The processor 202 may execute software instructions stored in the memory 204, to implement the image collection management system described herein. The image collection management system may be executed as part of another software application for managing image collections (e.g., part of another album application). Although the present application describes examples in which the image collection management system is executed by the electronic device 102 using instructions stored in the memory 204, the image collection management system may be implemented in other ways. For example, the image collection management system may run on a virtual machine (e.g., in a distributed computing system, or in a cloud-based computing system). The image collection management system may also be executed on a server and provided as a service to the electronic device 102 (e.g., the server analyzes the images for human-centric linkages and provides the rearranged images to the electronic device 102). Other such implementations may be possible within the scope of the present application.

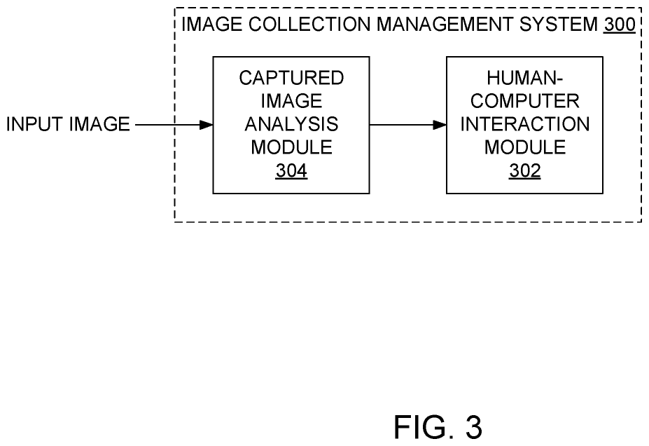

FIG. 3 illustrates an example image collection management system 300 including, in accordance with aspects of the present application, a human-computer interaction (HCl) module 302 and a captured document analysis module 304. The captured document analysis module 304 is configured to receive captured image(s) as input. For simplicity, the present application will describe the input simply as an input image. It should be understood that “input image” as used in the following discussion is intended to include a single static image or a single video (comprising a set of video images). It should also be understood that in some examples a plurality of input images (e.g., a plurality of photos and/or a plurality of videos) may be received by the image collection management system, to be analyzed in parallel or in series. The image collection management system 300 may receive the input image from various sources of captured images. For example, a camera application running on the electronic device 102 may, after capturing a new image, automatically provide the newly captured image as an input image to the image collection management system 300 to perform analysis. In another example, the image collection management system 300 may receive an input image from a database or repository of images (e.g., in the local memory 204 or the electronic device 102, or from an external memory). In examples where the image collection management system 300 is implemented on a server or in a cloud-based system, a plurality of input images may be provided, as an image collection, from an electronic device 102. For example, the electronic device 102 may request a server to perform human-centric analysis of the captured images in an image collection. Other such possibilities are within the scope of the present application.

The captured image analysis module 304 analyzes the input image and generates data representing detected linkages between humans in input image(s) and the overall image collection. The linkage data may be used by the HCl module 302 to provide a user interface that enables human-centric management and navigation of the image collection. For example, a user of the electronic device 102 may interact with the captured images in an image collection when the image collection management system renders the captured images and linkages, in a graphical user interface on the display screen 104, according to operations performed by the HCl module 302.

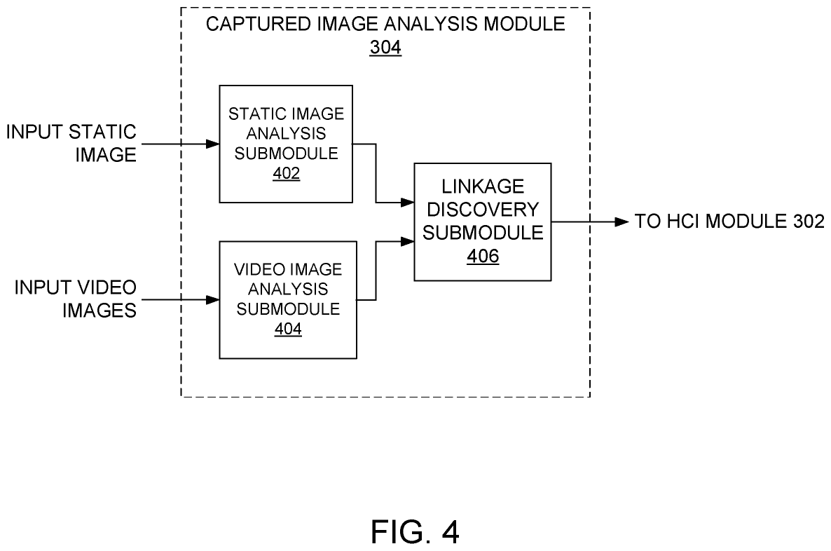

FIG. 4 illustrates example submodules of the captured document analysis module 304 including, in accordance with aspects of the present application, a static image analysis submodule 402 and a video image analysis submodule 404. The static image analysis submodule 402 is configured to receive a static images as input and generate metadata representing human(s) and scene recognized in the image. The video image analysis submodule 404 is configured to receive a set of video images (that together form a single video) as input and generate metadata representing human(s) and scene(s) recognized in the video. Both the image analysis module 402 and the video analysis module 404 provide the metadata output to a linkage discovery module sub 406. In turn, the linkage discovery module 406 generates linkage data that may be stored and that may also be provided as output to the HCl module 302. Although the example of FIG. 4 shows separate submodules for analyzing static images and video images, in some examples static images and video images may be analyzed by a single submodule (e.g., a single image analysis submodule).

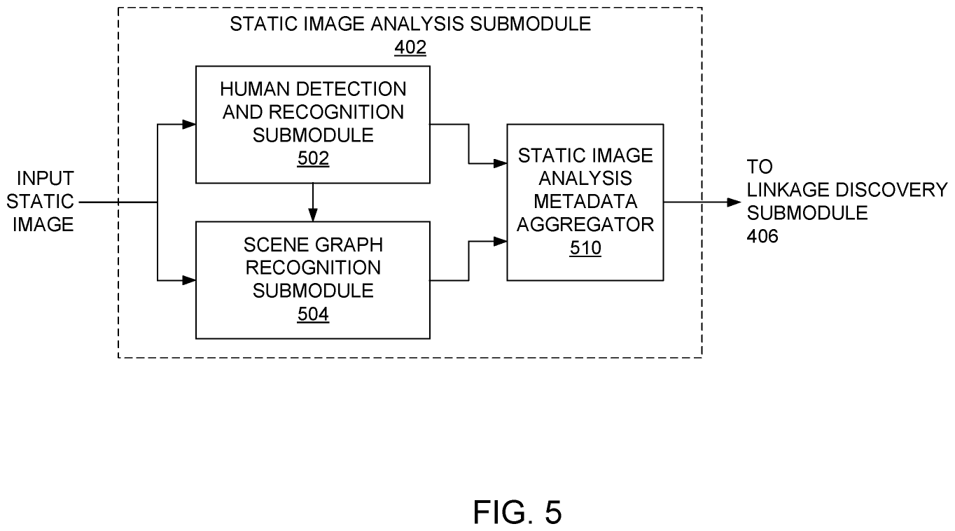

FIG. 5 illustrates example submodules of the static image analysis submodule 402 including, in accordance with aspects of the present application, a human detection and recognition submodule 502 and a scene graph recognition submodule 504. The human detection and recognition submodule 502 analyzes the input static image to detect and recognize any human(s) in the image, and outputs a set of metadata representing the detected and recognized human(s). The scene graph recognition submodule 504 receives the input image and also receives the metadata generated by the human detection and recognition submodule 502. The scene graph recognition submodule 504 analyzes the input image to recognize a scene in the image, and any human activities in the scene. The scene graph recognition submodule 504 outputs a set of metadata representing the recognized scene and any activities associated with the input image. Both the human detection and recognition submodule 502 and the scene graph recognition submodule 504 provide their respective generated metadata to a static image analysis metadata aggregator 510. In turn, the image analysis metadata aggregator 510 aggregates the two sets of metadata into a single set of metadata that is outputted to the linkage discovery module 406. The static image analysis metadata aggregator 510 may also format the metadata into a format that is useable by the linkage discovery submodule 406. Further details about the operation of the static image analysis submodule 402 and its submodules 502, 504, 510 will be discussed further below. It should be understood that the functions of two or more of the submodules 502, 504, 510 may be combined into one submodule.

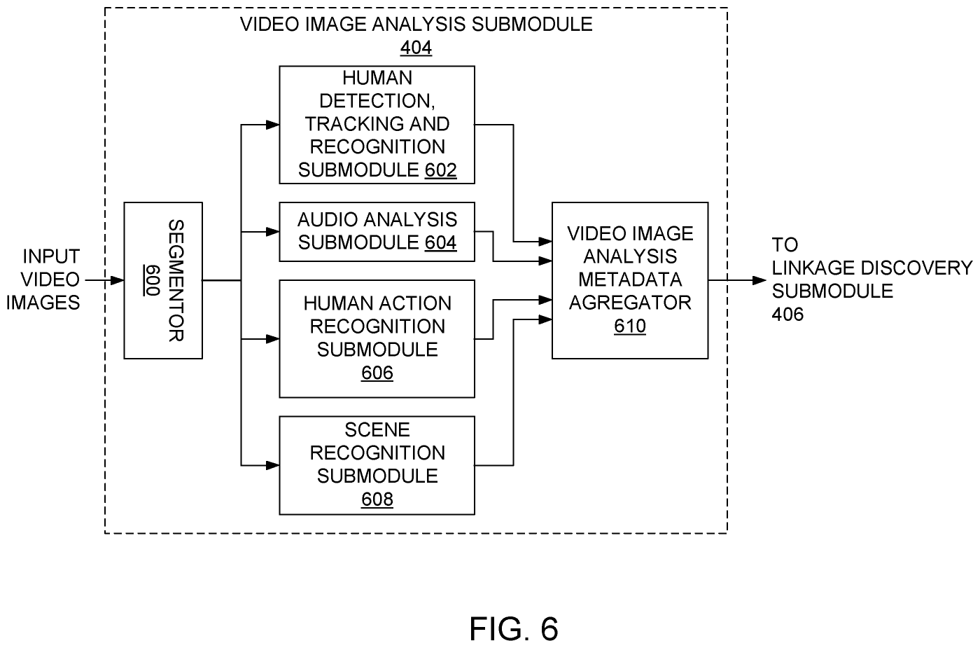

FIG. 6 illustrates example submodules of the video analysis submodule 404 including, in accordance with aspects of the present application, a segmentor 600, a human detection, tracking and recognition submodule 602, an audio analysis submodule 604, a human action recognition submodule 606, and a scene recognition submodule 608.

The segmentor 600 receives the set of video images (that together form the input video) and performs video segmentation to output two or more video segments. Each of the video segments is provided as input to each of the human detection, tracking and recognition submodule 602, the audio analysis submodule 604, the human action recognition submodule 606, and the scene recognition submodule 608. The human detection, tracking and recognition submodule 602 analyzes the video segment to detect, track and recognize human(s) in the video segment, and outputs a set of metadata including identifier(s) of the human(s). The audio analysis submodule 604 analyzes the audio data of the video segment to generate metadata including one or more labels representing a scene and/or activity in the video segment. The human action recognition submodule 606 analyzes the video segment to generate metadata including one or more labels representing a human action detected in the video segment. The scene recognition submodule 608 performs scene analysis to detect and recognize one or more scenes in the video segment, and outputs metadata representing the scene(s).

The human detection, tracking and recognition submodule 602, the audio analysis submodule 604, the human action recognition submodule 606 and the scene recognition submodule 608 all provide their respective metadata to a video image analysis metadata aggregator 610. In turn, the video analysis metadata aggregator 610 aggregates the received metadata into a single set of metadata that is outputted to the linkage discovery submodule 406. The video image analysis metadata aggregator 610 may also format the metadata into a format that is useable by the linkage discovery submodule 406. Further details about the operation of the video image analysis submodule 404 and its submodules 600, 602, 604, 606, 608, 610 will be discussed further below. It should be understood that the functions of two or more of the submodules 600, 602, 604, 606, 608, 610 may be combined into one submodule.

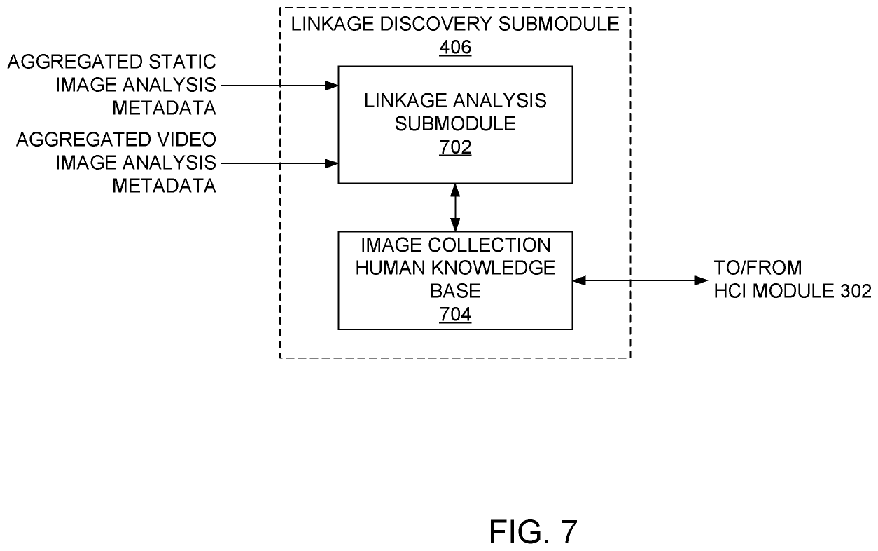

FIG. 7 illustrates example submodules of the linkage discovery submodule 406 including, in accordance with aspects of the present application, a linkage analysis submodule 702, and an image collection human knowledge base 704 configured for two-way interaction with the linkage analysis submodule 702. The image collection human knowledge base 704 provides information about human-centric linkages between images in an associated image collection. The image collection human knowledge base 704 is also configured for bidirectional interaction with the HCl module 302. The linkage analysis submodule 702 receives the aggregated metadata from the static image analysis metadata aggregator 510 and from the video image analysis metadata aggregator 610, and uses this metadata to generate and/or update linkage scores. The output from the linkage analysis submodule 702 is provided to the image collection human knowledge base 704 to update stored records with the linkage scores. The stored records from the image collection human knowledge base 704 may then be used by the HCl module 302 to provide a human-centric user interface for managing and/or navigating the image collection. Further details of the linkage discovery submodule 406 and its submodules 702, 704 will be discussed further below.

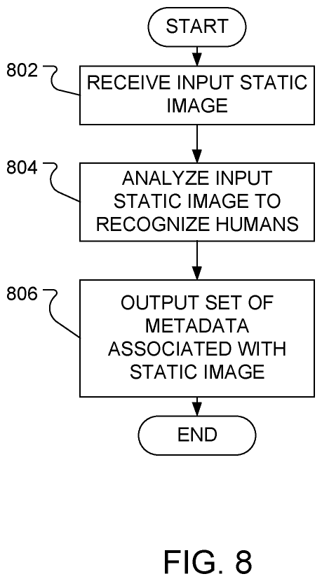

FIG. 8, illustrates example steps in a method of human detection according to an aspect of the present application. The method of FIG. 8 may be performed by the static image analysis submodule 402, for example. The human detection and recognition submodule 502 receives (step 802) an input image, in particular a static input image. The input static image may be received from a camera application of the electronic device 102, for example when a new image is captured. Alternatively, the input static image may have been captured previously and stored in the memory 204 of the electronic device 102. In this latter case, receiving (step 802) the input static image may occur on the basis of the image analysis module 402 requesting the input static image from the memory 204. As previously mentioned, the input static image may also be received from an external memory (e.g., from cloud-based storage), or (in the case where the image collection management system 300 is implemented external to the electronic device 102) from the electronic device 102, among other possibilities.

Subsequent to receiving (step 802) the input static image, the human detection and recognition submodule 502 may analyze (step 804) the input static image to recognize all the people, and respective attributes of the people, in the input image. The analyzing (step 804) may involve the human detection and recognition submodule 502 using any suitable human detection and recognition methods (e.g., using machine-learning techniques). For example, a suitable method for face detection, is described by Liu, Wei, et al. “Ssd: Single shot multibox detector.” European conference on computer vision. Springer, Cham, 2016. In another example, a suitable method for face recognition, is described by Schroff, Florian, Dmitry Kalenichenko, and James Philbin. “Facenet: A unified embedding for face recognition and clustering.” Proceedings of the IEEE conference on computer vision and pattern recognition. 2015.

After completing the analyzing (step 804) of the input static image, the human detection and recognition submodule 502 may output (step 806) a set of metadata associated with the input static image, to the static image analysis metadata aggregator 510. In some examples, the human detection and recognition submodule 502 may output the static image together with the generated set of metadata to the static image analysis metadata aggregator 510. If the static image is not outputted by the human detection and recognition submodule 502, the human detection and recognition submodule 502 may instead modify the static image (e.g., by inserting the metadata or adding a tag to reference the metadata) to associate the static image with the outputted metadata. In addition to providing, to the static image analysis metadata aggregator 510, the set of metadata associated with the input static image, the human detection and recognition submodule 502 may also output a subset of the set of metadata to the scene graph recognition submodule 504. For example, the human detection and recognition submodule 502 may output, to the scene graph recognition submodule 504, data defining a bounding box for each detected human in association with identification information for each detected human.

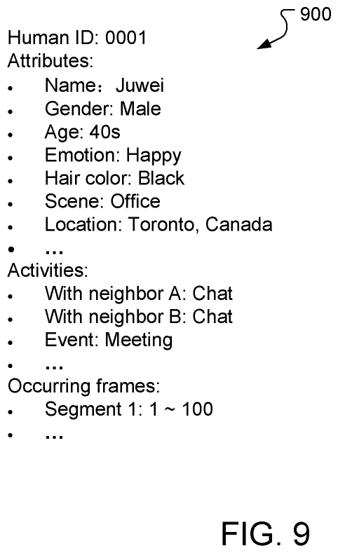

The set of metadata may, for example, include data in the form of a record for each human detected in the input static image. The data may include an identifier for the recognized human and an associated list of attributes of the recognized human. An example record 900 is illustrated in FIG. 9. The identifier may be an automatically generated identifier that uniquely identifies a particular human in the image collection. In some examples, the identifier may uniquely identify the human in an image database (e.g., in the image collection human knowledge base 704) that is larger than the image collection. Attributes associated with the human may include attributes that are determined from the input static image (e.g., emotion, scene, location, activity, etc.) as well as attributes that are determined from another data source such as the image collection human knowledge base 704 (e.g., name, gender, age, hair color, etc.). In aspects of the present application the record 900 may be formatted using JavaScript Object Notation (JSON). JSON is a known, lightweight data-interchange format. Where multiple humans have been detected and recognized in the static image, the metadata may include an identifier for each respective recognized human, and a respective associated list of attributes for each recognized human. The data corresponding to each recognized human may be formatted in respective records.

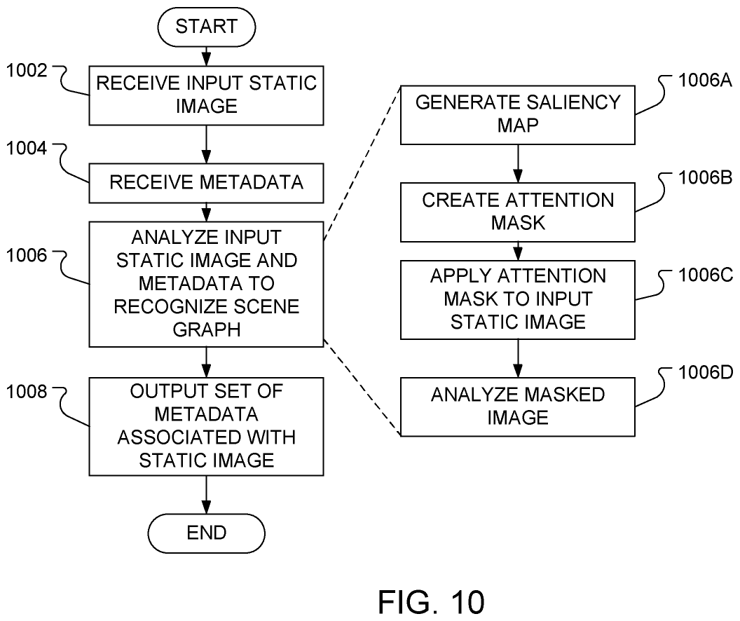

Referring to FIG. 10, an example method of scene graph recognition according to an aspect of the present application is shown. The method may be performed by the scene graph recognition submodule 504 which receives (step 1002) the input static image. The manner of receiving (step 1002) the input static image will generally be the same as the manner by which the human detection and recognition submodule 502 receives (step 802) the input static image. The scene graph recognition submodule 504 also receives (step 1004) metadata from the human detection and recognition submodule 502. Subsequent to receiving (step 1002) the input static image and receiving (step 1004) the metadata, the scene graph recognition submodule 504 may analyze (step 1006) the input static image, in the presence of additional information provided by the metadata from the human detection and recognition submodule 502, to recognize the scene and any human activities in the scene. The analyzing (step 1006) may involve using any suitable scene graph recognition methods (e.g., using machine-learning techniques). One known scene graph recognition method that may be used to analyze the input static image in the presence of additional information provided by the metadata is presented in Xu, Danfei, Yuke Zhu, Christopher B. Choy and Li Fei-Fei, “Scene graph generation by iterative message passing” Computer Vision and Pattern Recognition, CVPR, 2017.

Unlike traditional scene graph recognition submodules, which analyze all the objects detected in an input image, the scene graph recognition submodule 504 may be configured to implement an approach to the analyzing (step 1006) wherein only human objects are considered and other objects are ignored as described in further detail below. This human-centric approach may be considered to significantly simplify scene graph recognition and make the analyzing (step 1006), by the scene graph recognition submodule 504, more realizable. In some examples, some types of non-human objects (e.g., animals) may be considered in addition to human objects.

In computer vision, a saliency map is an image that shows a unique quality for each pixel. The goal of a saliency map is to simplify and/or change the representation of an image into something that is more meaningful and easier to analyze. As part of the analyzing (step 1006), the scene graph recognition submodule 504 may analyze (step 1006A) the input static image to generate a saliency map. For information on analyzing an input static image to generate a saliency map, see R. Margolin, A. Tal and L. Zelnik-Manor, “What Makes a Patch Distinct?” 2013 IEEE Conference on Computer Vision and Pattern Recognition, Portland, Oreg., 2013, pp. 1139-1146. The scene graph recognition submodule 504 then creates (step 1006B), based on the saliency map, an attention mask. The scene graph recognition submodule 504 then applies (step 1006C) the attention mask to the input static image to generate a masked image that may be understood to help the scene graph recognition submodule 504 to focus on a region of the input static image that contains a human. The scene graph recognition submodule 504 may then analyze (step 1006D) the masked image.

After completion of the analyzing (step 1006D) of the masked image, the scene graph recognition submodule 504 outputs (step 1008) a set of metadata associated with the input static image, to the image analysis metadata aggregator 510. In some examples, the scene graph recognition submodule 504 may output the static image together with the generated set of metadata to the static image analysis metadata aggregator 510. If the static image is not outputted by the scene graph recognition submodule 504, the scene graph recognition submodule 504 may instead modify the static image (e.g., by inserting the metadata or adding a tag to reference the metadata) to associate the static image with the outputted metadata.

The set of metadata output (step 1008) by the scene graph recognition submodule 504 includes data for each recognized person, which may be in the form of a record. The data includes an identifier for the recognized person; one or more attributes associated with the recognized person; optionally an activity associated with the recognized person; and one or more labels for the scene. The metadata outputted by the scene graph recognition submodule 504 may be in the form of records for each recognized person, or may be in the form of a single record for the scene. Other formats may be suitable.

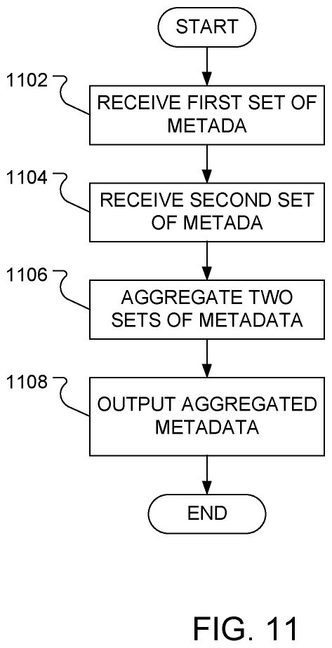

Referring to FIG. 11, an example method of static image analysis metadata aggregation according to an aspect of the present application is shown. The method may be performed by the static image analysis metadata aggregator 510 which receives (step 1102), from the human detection and recognition submodule 502, a first set of metadata associated, by the human detection and recognition submodule 502, with the input static image. The static image analysis metadata aggregator 510 also receives (step 1104), from the scene graph recognition submodule 504, a second set of metadata associated, by the scene graph recognition submodule 504, with the input static image. In some examples, the static image analysis metadata aggregator 510 may also receive the input static image. The image analysis metadata aggregator 510 then aggregates (step 1106) the received sets of metadata to a single set of metadata. Aggregating the metadata may involve simply combining the data from each of the first and second sets of metadata into a single larger set of metadata. In some examples, aggregating the metadata may involve removing any redundant data. The image analysis metadata aggregator 510 then outputs (step 1108) the aggregated single set of metadata to the linkage discovery module 406. The aggregated single set of metadata may replace the first and second sets of metadata, or the first and second sets of metadata may be kept with the addition of the aggregated single set of metadata. In some examples, the static image analysis metadata aggregator 510 may also output the input static image that is associated with the aggregated single set of metadata. If the static image is not outputted by the static image analysis metadata aggregator 510, the static image analysis metadata aggregator 510 may instead modify the static image (e.g., by inserting the metadata or adding a tag to reference the metadata) to associate the static image with the aggregated single set of metadata.

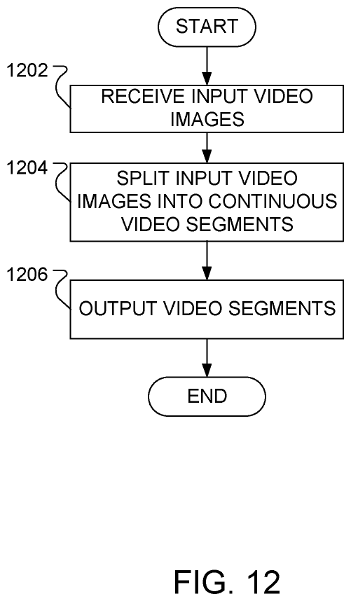

Referring to FIG. 12, an example method of video segmentation according to aspects of the present application is shown. The method may be performed by the segmentor 600 of the video analysis module 404 (see FIG. 6) which receives (step 1202) an input video (in the form of a set of input video images). The input video images may be received from a camera or video application of the electronic device 102, for example when a new video is captured. Alternatively, the input video images may have been captured previously and stored in the memory 204 of the electronic device 102. In this latter case, receiving (step 1202) the input video may occur on the basis of requesting the input video from the memory 204. As previously mentioned, the input video images may also be received from an external memory (e.g., from cloud-based storage), or (in the case where the image collection management system 300 is implemented external to the electronic device 102) from the electronic device 102, among other possibilities.

The segmentor 600 splits or partitions (step 1204) the input video images into two or more continuous segments. The segmentor 600 may, for example, split or partition the input video images according to detected scene changes. The video segments may be considered to represent basic processing units. The segmentor 600 then outputs (step 1206) each of the video segments to the human detection, tracking and recognition submodule 602, the audio analysis submodule 604, the human action recognition submodule 606 and the scene recognition submodule 608.

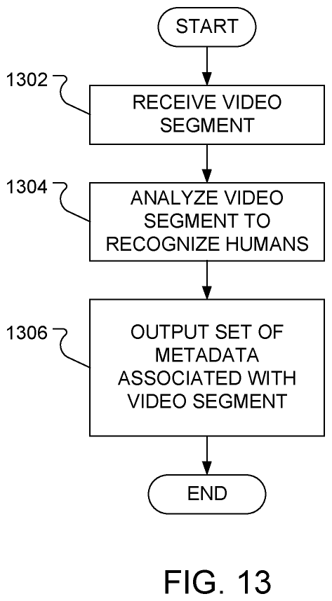

Referring to FIG. 13, an example method of human detection, tracking and recognition according to aspects of the present application is shown. The method may be performed by the human detection, tracking and recognition submodule 602 which receives (step 1302) a video segment from the segmentor 600. The human detection, tracking and recognition submodule 602 may then analyze (step 1304) the video segment to detect and recognize the human(s), and respective attributes of the human(s), in the video segment. The analyzing (step 1304) may involve the human detection, tracking and recognition submodule 602 using any suitable human detection, tracking and recognition methods (e.g., using machine-learning techniques). After completing the analyzing (step 1304) of the video segment, the human detection, tracking and recognition submodule 602 outputs (step 1306) a set of metadata associated with the video segment, to the video image analysis metadata aggregator 610. In some examples, the human detection, tracking and recognition submodule 602 may output the video segment together with the generated set of metadata to the video image analysis metadata aggregator 610. If the video segment is not outputted by the human detection, tracking and recognition submodule 602, the human detection, tracking and recognition submodule 602 may instead modify the video segment (e.g., by inserting the metadata or adding a tag to reference the metadata) to associate the video segment with the outputted metadata. The set of metadata may, for example, include data in the form of a record for each human detected in the video segment. The data may include an identifier for the recognized human and an associated list attributes of the recognized human. The metadata may, in some examples, be similar to the metadata outputted by the human detection and recognition submodule 502 described previously.

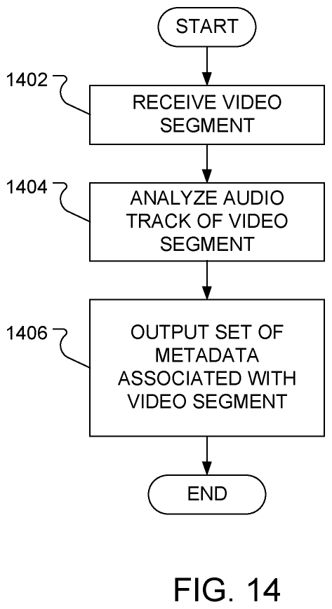

Referring to FIG. 14, an example method of audio analysis according to aspects of the present application is shown. The method may be performed by the audio analysis submodule 604 which receives (step 1402) a video segment. The audio analysis submodule 604 may then analyze (step 1404) an audio track of the video segment using any suitable audio analysis methods (e.g., using machine-learning techniques). After completing analyzing (step 1404) of the audio track of the video segment, the audio analysis submodule 604 outputs (step 1406) a set of metadata associated with the video segment, to the video analysis metadata aggregator 610. In some examples, the audio analysis submodule 604 may output the video segment together with the generated set of metadata to the video image analysis metadata aggregator 610. If the video segment is not outputted by the audio analysis submodule 604, the audio analysis submodule 604 may instead modify the video segment (e.g., by inserting the metadata or adding a tag to reference the metadata) to associate the video segment with the outputted metadata. The metadata output of the audio analysis submodule 604 may include one or more labels to describe the audio. A label may be generated from a database of different descriptive labels, for example. A label may be descriptive of a type of sound in the scene, including ambient sounds as well as musical sounds. The label may, for example, be selected from among the following example labels:

### Speech

### Laughter

### Crying

### Singing

### Applause

### Cheering

### Guitar

### Piano

### Violin

### Brass Instrument

### Woodwind Instrument

### Drum

### Bell

### Electronic Device

### Tool Use

### Road Vehicle

### Rail Vehicle

### Aircraft

### Boat

### Siren

### Dog Bark

### Cat Meow

### Bird Chirp

### Rodent Squeak

### Duck Quack

### Farm Animal

### Wind

### Water Flow

### Fire

### Thunderous Blast

### Strange Noise

### Silence

### Music

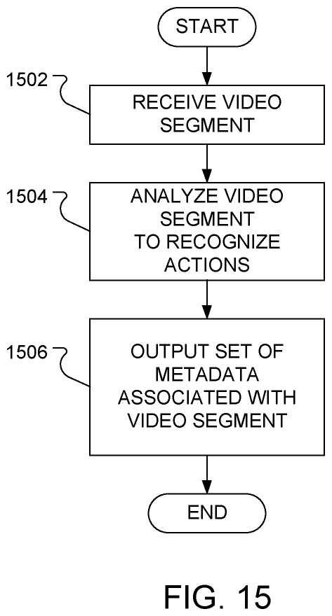

Referring to FIG. 15, an example method of human action recognition according to aspects of the present application according to an aspect of the present application is shown. The method may be performed by the human action recognition submodule 606, which receives (step 1502) a video segment. The human action recognition submodule 606 then analyzes (step 1504) the video segment using any suitable human action recognition methods (e.g., using machine learning techniques). After completing analyzing (step 1504) the video segment, the human action recognition submodule 606 outputs (step 1506) a set of metadata associated with the video segment, to the video image analysis metadata aggregator 610. In some examples, the human action recognition submodule 606 may output the video segment together with the generated set of metadata to the video image analysis metadata aggregator 610. If the video segment is not outputted by the human action recognition submodule 606, the human action recognition submodule 606 may instead modify the video segment (e.g., by inserting the metadata or adding a tag to reference the metadata) to associate the video segment with the outputted metadata. The metadata output of the human action recognition submodule 606 may include one or more labels to describe the human action. A label may be generated from a database of different descriptive labels, for example. A label may be descriptive of a type of human action in the scene, including an action that interacts with another object (or another human). The label may, for example, be selected from among the following example labels:

| id | label0 | label |
|---|---|---|
| 0 | applauding | applauding |
| 1 | blowing_bubbles | blowing bubbles |
| 2 | brushing_teeth | brushing teeth |
| 3 | cleaning_the_floor | cleaning the floor |
| 4 | climbing | climbing |
| 5 | cooking | cooking |
| 6 | cutting_trees | cutting trees |
| 7 | cutting_vegetables | cutting vegetables |
| 8 | drinking | drinking |
| 9 | feeding_a_horse | feeding a horse |
| 10 | fishing | fishing |
| 11 | fixing_a_bike | fixing a bike |
| 12 | fixing_a_car | fixing a car |
| 13 | gardening | gardening |
| 14 | holding_an_umbrella | holding an umbrella |
| 15 | jumping | jumping |
| 16 | looking_through_a_microscope | looking through a microscope |
| 17 | looking_through_a_telescope | looking through a telescope |
| 18 | phoning | phoning |
| 19 | playing_guitar | playing guitar |
| 20 | playing_violin | playing violin |
| 21 | pouring_liquid | pouring liquid |
| 22 | pushing_a_cart | pushing a cart |
| 23 | reading | reading |
| 24 | riding_a_bike | riding a bike |
| 25 | riding_a_horse | riding a horse |
| 26 | rowing_a_boat | rowing a boat |
| 27 | running | running |
| 28 | shooting_an_arrow | shooting an arrow |
| 29 | smoking | smoking |
| 30 | taking_photos | taking photos |
| 31 | texting_message | texting message |
| 32 | throwing_frisby | throwing frisby |
| 33 | using_a_computer | using a computer |
| 34 | walking_the_dog | walking the dog |
| 35 | washing_dishes | washing dishes |
| 36 | watching_TV | watching TV |
| 37 | waving_hands | waving hands |
| 38 | writing_on_a_board | writing on a board |
| 39 | writing_on_a_book | writing on a book |

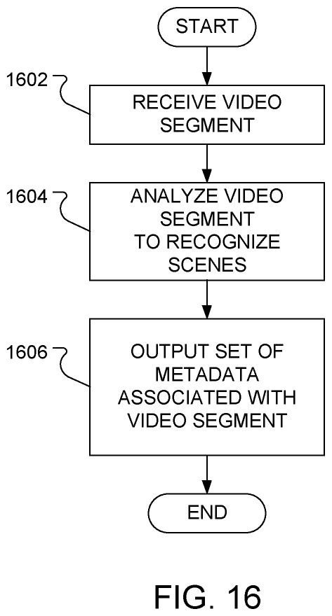

Referring to FIG. 16, an example method of scene recognition according to aspects of the present application is shown. The method may be performed by the scene recognition submodule 608 which receives (step 1602) a video segment from the segmentor 600. The scene recognition submodule 608 analyzes (step 1604) the video segment using any suitable scene recognition methods (e.g., using machine-learning techniques). For example scene recognition methods, see Zhou, Bolei, et al. “Places: A 10 million image database for scene recognition.” IEEE transactions on pattern analysis and machine intelligence 40.6 (2017): 1452-1464; and Hu, Jie, Li Shen, and Gang Sun. “Squeeze-and-excitation networks.” Proceedings of the IEEE conference on computer vision and pattern recognition. 2018.

After completing analyzing (step 1604) the video segment, the scene recognition submodule 608 outputs (step 1606) a set of metadata associated with the video segment, to the video image analysis metadata aggregator 610. In some examples, the scene recognition submodule 608 may output the video segment together with the generated set of metadata to the video image analysis metadata aggregator 610. If the video segment is not outputted by the scene recognition submodule 608, the scene recognition submodule 608 may instead modify the video segment (e.g., by inserting the metadata or adding a tag to reference the metadata) to associate the video segment with the outputted metadata. The metadata output of the scene recognition submodule 608 may include one or more labels to describe the scene. A label may be generated from a database of different descriptive labels, for example. Multiple labels may be used to describe a scene, for example with different levels of specificity. The label may, for example, be selected from among the following example labels:

| id | label0 | label |
|---|---|---|
| 0 | /a/airfield 2 | airfield |
| 1 | /a/airplane_cabin 1 | airplane cabin |
| 2 | /a/airport_terminal 1 | airport terminal |
| 3 | /a/alcove 1 | alcove |
| 4 | /a/alley 2 | alley |
| 5 | /a/amphitheater 2 | amphitheater |
| 6 | /a/amusement_arcade 1 | amusement arcade |
| 7 | /a/amusement_park 2 | amusement park |
| 8 | /a/apartment_building/outdoor 2 | apartment building |
| 9 | /a/aquarium 1 | aquarium |
| 10 | /a/aqueduct 2 | aqueduct |
| 11 | /a/arcade 1 | arcade |
| 12 | /a/arch 2 | arch |
| 13 | /a/archaeological_excavation 1 | archaeological excavation |
| 14 | /a/archive 1 | archive |
| 15 | /a/arena/hockey 1 | arena |
| 16 | /a/arena/performance 1 | arena |
| 17 | /a/arena/rodeo 1 | arena |
| 18 | /a/army_base 2 | army base |
| 19 | /a/art_gallery 1 | art gallery |
| 20 | /a/art_school 1 | art school |
| 21 | /a/art_studio 1 | art studio |
| 22 | /a/artists_loft 1 | artists loft |
| 23 | /a/assembly_line 1 | assembly line |
| 24 | /a/athletic_field/outdoor 2 | athletic field |
| 25 | /a/atrium/public 1 | atrium |
| 26 | /a/attic 1 | attic |
| 27 | /a/auditorium 1 | auditorium |
| 28 | /a/auto_factory 1 | auto factory |
| 29 | /a/auto_showroom 1 | auto showroom |
| 30 | /b/badlands 2 | badlands |
| 31 | /b/bakery/shop 1 | bakery |
| 32 | /b/balcony/exterior 2 | balcony |
| 33 | /b/balcony/interior 2 | balcony |
| 34 | /b/ball_pit 1 | ball pit |
| 35 | /b/ballroom 1 | ballroom |
| 36 | /b/bamboo_forest 2 | bamboo forest |
| 37 | /b/bank_vault 1 | bank vault |
| 38 | /b/banquet_hall 1 | banquet hall |
| 39 | /b/bar 1 | bar |
| 40 | /b/barn 2 | barn |
| 41 | /b/barndoor 2 | barn door |
| 42 | /b/baseball_field 2 | baseball field |
| 43 | /b/basement 1 | basement |
| 44 | /b/basketball_court/indoor 1 | basketball court |
| 45 | /b/bathroom 1 | bathroom |
| 46 | /b/bazaar/indoor 1 | bazaar |
| 47 | /b/bazaar/outdoor 2 | bazaar |
| 48 | /b/beach 2 | beach |
| 49 | /b/beach_house 2 | beach house |
| 50 | /b/beauty_salon 1 | beauty salon |
| 51 | /b/bedchamber 1 | bedchamber |
| 52 | /b/bedroom 1 | bedroom |
| 53 | /b/beer_garden 2 | beer garden |
| 54 | /b/beer_hall 1 | beer hall |
| 55 | /b/berth 1 | berth |
| 56 | /b/biology_laboratory 1 | biology laboratory |
| 57 | /b/boardwalk 2 | boardwalk |
| 58 | /b/boat_deck 2 | boat deck |
| 59 | /b/boathouse 2 | boathouse |
| 60 | /b/bookstore 1 | bookstore |
| 61 | /b/booth/indoor 1 | booth |
| 62 | /b/botanical_garden 2 | botanical garden |
| 63 | /b/bow_window/indoor 1 | bow window |
| 64 | /b/bowling_alley 1 | bowling alley |
| 65 | /b/boxing_ring 1 | boxing ring |
| 66 | /b/bridge 2 | bridge |
| 67 | /b/building_facade 2 | building facade |
| 68 | /b/bullring 2 | bullring |
| 69 | /b/burial_chamber 1 | burial chamber |
| 70 | /b/bus_interior 1 | bus interior |
| 71 | /b/bus_station/indoor 2 | bus station |
| 72 | /b/butchers_shop 1 | butchers shop |
| 73 | /b/butte 2 | butte |
| 74 | /c/cabin/outdoor 2 | cabin |
| 75 | /c/cafeteria 1 | cafeteria |
| 76 | /c/campsite 2 | campsite |
| 77 | /c/campus 2 | campus |
| 78 | /c/canal/natural 2 | canal |
| 79 | /c/canal/urban 2 | canal |
| 80 | /c/candy_store 1 | candy store |
| 81 | /c/canyon 2 | canyon |
| 82 | /c/car_interior 1 | car interior |
| 83 | /c/carrousel 2 | carrousel |
| 84 | /c/castle 2 | castle |
| 85 | /c/catacomb 1 | catacomb |
| 86 | /c/cemetery 2 | cemetery |
| 87 | /c/chalet 2 | chalet |
| 88 | /c/chemistry_lab 1 | chemistry lab |
| 89 | /c/childs_room 1 | child's room |
| 90 | /c/church/indoor 1 | church |
| 91 | /c/church/outdoor 2 | church |
| 92 | /c/classroom 1 | classroom |
| 93 | /c/clean_room 1 | clean room |
| 94 | /c/cliff 2 | cliff |
| 95 | /c/closet 1 | closet |
| 96 | /c/clothing_store 1 | clothing store |
| 97 | /c/coast 2 | coast |
| 98 | /c/cockpit 1 | cockpit |
| 99 | /c/coffee_shop 1 | coffee shop |
| 100 | /c/computer_room 1 | computer room |
| 101 | /c/conference_center 1 | conference center |
| 102 | /c/conference_room 1 | conference room |
| 103 | /c/construction_site 2 | construction site |
| 104 | /c/corn_field 2 | com field |
| 105 | /c/corral 2 | corral |
| 106 | /c/corridor 1 | corridor |
| 107 | /c/cottage 2 | cottage |
| 108 | /c/courthouse 2 | courthouse |
| 109 | /c/courtyard 2 | courtyard |
| 110 | /c/creek 2 | creek |
| 111 | /c/crevasse 2 | crevasse |
| 112 | /c/crosswalk 2 | crosswalk |
| 113 | /d/dam 2 | dam |
| 114 | /d/delicatessen 1 | delicatessen |
| 115 | /d/department_store 1 | department store |
| 116 | /d/desert/sand 2 | desert |
| 117 | /d/desert/vegetation 2 | desert |
| 118 | /d/desert_road 2 | desert road |
| 119 | /d/diner/outdoor 2 | diner |
| 120 | /d/dining_hall 1 | dining hall |
| 121 | /d/dining_room 1 | dining room |
| 122 | /d/discotheque 1 | discotheque |
| 123 | /d/doorway/outdoor 2 | doorway |
| 124 | /d/dorm_room 1 | dorm room |
| 125 | /d/downtown 2 | downtown |
| 126 | /d/dressing_room 1 | dressing room |
| 127 | /d/driveway 2 | driveway |
| 128 | /d/drugstore 1 | drugstore |
| 129 | /e/elevator/door 1 | elevator |
| 130 | /e/elevator_lobby 1 | elevator lobby |
| 131 | /e/elevator_shaft 1 | elevator shaft |
| 132 | /e/embassy 2 | embassy |
| 133 | /e/engine_room 1 | engine room |
| 134 | /e/entrance_hall 1 | entrance hall |
| 135 | /e/escalator/indoor 1 | escalator |
| 136 | /e/excavation 2 | excavation |
| 137 | /f/fabric_store 1 | fabric store |
| 138 | /f/farm 2 | farm |
| 139 | /f/fastfood_restaurant 1 | fast food restaurant |
| 140 | /f/field/cultivated 2 | field |
| 141 | /f/field/wild 2 | field |
| 142 | /f/field_road 2 | field road |
| 143 | /f/fire_escape 2 | fire escape |
| 144 | /f/fire_station 2 | fire station |
| 145 | /f/fishpond 2 | fishpond |
| 146 | /f/flea_market/indoor 1 | flea market |
| 147 | /f/florist_shop/indoor 1 | florist shop |
| 148 | /f/food_court 1 | food court |
| 149 | /f/football_field 2 | football field |
| 150 | /f/forest/broadleaf 2 | forest |
| 151 | /f/forest_path 2 | forest path |
| 152 | /f/forest_road 2 | forest road |
| 153 | /f/formal_garden 2 | formal garden |
| 154 | /f/fountain 2 | fountain |
| 155 | /g/galley 1 | galley |
| 156 | /g/garage/indoor 1 | garage |
| 157 | /g/garage/outdoor 2 | garage |
| 158 | /g/gas_station 2 | gas station |
| 159 | /g/gazebo/exterior 2 | gazebo |
| 160 | /g/general_store/indoor 1 | general store |
| 161 | /g/general_store/outdoor 2 | general store |
| 162 | /g/gift_shop 1 | gift shop |
| 163 | /g/glacier 2 | glacier |
| 164 | /g/golf_course 2 | golf course |
| 165 | /g/greenhouse/indoor 1 | greenhouse |
| 166 | /g/greenhouse/outdoor 2 | greenhouse |
| 167 | /g/grotto 2 | grotto |
| 168 | /g/gymnasium/indoor 1 | gymnasium |
| 169 | /h/hangar/indoor 1 | hangar |
| 170 | /h/hangar/outdoor 2 | hangar |
| 171 | /h/harbor 2 | harbor |
| 172 | /h/hardware_store 1 | hardware store |
| 173 | /h/hayfield 2 | hayfield |
| 174 | /h/heliport 2 | heliport |
| 175 | /h/highway 2 | highway |
| 176 | /h/home_office 1 | home office |
| 177 | /h/home_theater 1 | home theater |
| 178 | /h/hospital 2 | hospital |
| 179 | /h/hospital_room 1 | hospital room |
| 180 | /h/hot_spring 2 | hot spring |
| 181 | /h/hotel/outdoor 2 | hotel |
| 182 | /h/hotel_room 1 | hotel room |
| 183 | /h/house 2 | house |
| 184 | /h/hunting_lodge/outdoor 2 | hunting lodge |
| 185 | /i/ice_cream_parlor 1 | ice cream parlor |
| 186 | /i/ice_floe 2 | ice floe |
| 187 | /i/ice_shelf 2 | ice shelf |
| 188 | /i/ice_skating_rink/indoor 1 | ice skating rink |
| 189 | /i/ice_skating_rink/outdoor 2 | ice skating rink |
| 190 | /i/iceberg 2 | iceberg |
| 191 | /i/igloo 2 | igloo |
| 192 | /i/industrial_area 2 | industrial area |
| 193 | /i/inn/outdoor 2 | inn |
| 194 | /i/islet 2 | islet |
| 195 | /j/jacuzzi/indoor 1 | Jacuzzi |
| 196 | /j/jail_cell 1 | jail cell |
| 197 | /j/japanese_garden 2 | Japanese garden |
| 198 | /j/jewelry_shop 1 | jewelry shop |
| 199 | /j/junkyard 2 | junkyard |
| 200 | /k/kasbah 2 | Kasbah |
| 201 | /k/kennel/outdoor 2 | kennel |
| 202 | /k/kindergarden_classroom 1 | kinder garden classroom |
| 203 | /k/kitchen 1 | kitchen |
| 204 | /l/lagoon 2 | lagoon |
| 205 | /l/lake/natural 2 | lake |
| 206 | /l/landfill 2 | landfill |
| 207 | /l/landing_deck 2 | landing deck |
| 208 | /l/laundromat 1 | laundromat |
| 209 | /l/lawn 2 | lawn |
| 210 | /l/lecture_room 1 | lecture room |
| 211 | /l/legislative_chamber 1 | legislative chamber |
| 212 | /l/library/indoor 1 | library |
| 213 | /l/library/outdoor 2 | library |
| 214 | /l/lighthouse 2 | lighthouse |
| 215 | /l/living_room 1 | living room |
| 216 | /l/loading_dock 2 | loading dock |
| 217 | /l/lobby 1 | lobby |
| 218 | /l/lock_chamber 2 | lock chamber |
| 219 | /l/locker_room 1 | locker room |
| 220 | /m/mansion 2 | mansion |
| 221 | /m/manufactured_home 2 | manufactured home |
| 222 | /m/market/indoor 1 | market |
| 223 | /m/market/outdoor 2 | market |
| 224 | /m/marsh 2 | marsh |
| 225 | /m/martial_arts_gym 1 | martial arts gym |
| 226 | /m/mausoleum 2 | mausoleum |
| 227 | /m/medina 2 | medina |
| 228 | /m/mezzanine 1 | mezzanine |
| 229 | /m/moat/water 2 | moat |
| 230 | /m/mosque/outdoor 2 | mosque |
| 231 | /m/motel 2 | motel |
| 232 | /m/mountain 2 | mountain |
| 233 | /m/mountain_path 2 | mountain path |
| 234 | /m/mountain_snowy 2 | mountain snowy |
| 235 | /m/movie_theater/indoor 1 | movie theater |
| 236 | /m/museum/indoor 1 | museum |
| 237 | /m/museum/outdoor 2 | museum |
| 238 | /m/music_studio 1 | music studio |
| 239 | /n/natural_history_museum 1 | natural history museum |
| 240 | /n/nursery 1 | nursery |
| 241 | /n/nursing_home 1 | nursing home |
| 242 | /o/oast_house 2 | oast house |
| 243 | /o/ocean 2 | ocean |
| 244 | /o/office 1 | office |
| 245 | /o/office_building 2 | office building |
| 246 | /o/office_cubicles 1 | office cubicles |
| 247 | /o/oilrig 2 | oilrig |
| 248 | /o/operating_room 1 | operating room |
| 249 | /o/orchard 2 | orchard |
| 250 | /o/orchestra_pit 1 | orchestra pit |
| 251 | /p/pagoda 2 | pagoda |
| 252 | /p/palace 2 | palace |
| 253 | /p/pantry 1 | pantry |
| 254 | /p/park 2 | park |
| 255 | /p/parking_garage/indoor 1 | parking garage |
| 256 | /p/parking_garage/outdoor 2 | parking garage |
| 257 | /p/parking_lot 2 | parking lot |
| 258 | /p/pasture 2 | pasture |
| 259 | /p/patio 2 | patio |
| 260 | /p/pavilion 2 | pavilion |
| 261 | /p/pet_shop 1 | pet shop |
| 262 | /p/pharmacy 1 | pharmacy |
| 263 | /p/phone_booth 2 | phone booth |
| 264 | /p/physics_laboratory 1 | physics laboratory |
| 265 | /p/picnic_area 2 | picnic area |
| 266 | /p/pier 2 | pier |
| 267 | /p/pizzeria 1 | pizzeria |
| 268 | /p/playground 2 | playground |
| 269 | /p/playroom 1 | playroom |
| 270 | /p/plaza 2 | plaza |
| 271 | /p/pond 2 | pond |
| 272 | /p/porch 2 | porch |
| 273 | /p/promenade 2 | promenade |
| 274 | /p/pub/indoor 1 | pub |
| 275 | /r/racecourse 2 | racecourse |
| 276 | /r/raceway 2 | raceway |
| 277 | /r/raft 2 | raft |
| 278 | /r/railroad_track 2 | railroad track |
| 279 | /r/rainforest 2 | rainforest |
| 280 | /r/reception 1 | reception |
| 281 | /r/recreation_room 1 | recreation room |
| 282 | /r/repair_shop 1 | repair shop |
| 283 | /r/residential_neighborhood 2 | residential neighborhood |
| 284 | /r/restaurant 1 | restaurant |
| 285 | /r/restaurant_kitchen 1 | restaurant kitchen |
| 286 | /r/restaurant_patio 2 | restaurant patio |
| 287 | /r/rice_paddy 2 | rice paddy |
| 288 | /r/river 2 | river |
| 289 | /r/rock_arch 2 | rock arch |
| 290 | /r/roof_garden 2 | roof garden |
| 291 | /r/rope_bridge 2 | rope bridge |
| 292 | /r/ruin 2 | ruin |
| 293 | /r/runway 2 | runway |
| 294 | /s/sandbox 2 | sandbox |
| 295 | /s/sauna 1 | sauna |
| 296 | /s/schoolhouse 2 | schoolhouse |
| 297 | /s/science_museum 1 | science museum |
| 298 | /s/server_room 1 | server room |
| 299 | /s/shed 2 | shed |
| 300 | /s/shoe_shop 1 | shoe shop |
| 301 | /s/shopfront 2 | shopfront |
| 302 | /s/shopping_mall/indoor 1 | shopping mall |
| 303 | /s/shower 1 | shower |
| 304 | /s/ski_resort 2 | ski resort |
| 305 | /s/ski_slope 2 | ski slope |
| 306 | /s/sky 2 | sky |
| 307 | /s/skyscraper 2 | skyscraper |
| 308 | /s/slum 2 | slum |
| 309 | /s/snowfield 2 | snowfield |
| 310 | /s/soccer_field 2 | soccer field |
| 311 | /s/stable 1 | stable |
| 312 | /s/stadium/baseball 2 | stadium |
| 313 | /s/stadium/football 2 | stadium |
| 314 | /s/stadium/soccer 2 | stadium |
| 315 | /s/stage/indoor 1 | stage |
| 316 | /s/stage/outdoor 2 | stage |
| 317 | /s/staircase 1 | staircase |
| 318 | /s/storage_room 1 | storage room |
| 319 | /s/street 2 | street |
| 320 | /s/subway_station/platform 1 | subway station |
| 321 | /s/supermarket 1 | supermarket |
| 322 | /s/sushi_bar 1 | sushi bar |
| 323 | /s/swamp 2 | swamp |
| 324 | /s/swimming_hole 1 | swimming hole |
| 325 | /s/swimming_pool/indoor 1 | swimming pool |
| 326 | /s/swimming_pool/outdoor 2 | swimming pool |
| 327 | /s/synagogue/outdoor 2 | synagogue |
| 328 | /t/television_room 1 | television room |
| 329 | /t/television_studio 1 | television studio |
| 330 | /t/temple/asia 2 | temple |
| 331 | /t/throne_room 1 | throne room |
| 332 | /t/ticket_booth 1 | ticket booth |
| 333 | /t/topiary_garden 2 | topiary garden |
| 334 | /t/tower 2 | tower |
| 335 | /t/toyshop 1 | toyshop |
| 336 | /t/train_interior 1 | train interior |
| 337 | /t/train_station/platform 1 | train station |
| 338 | /t/tree_farm 2 | tree farm |
| 339 | /t/tree_house 2 | tree house |
| 340 | /t/trench 2 | trench |
| 341 | /t/tundra 2 | tundra |
| 342 | /u/underwater/ocean_deep 2 | underwater |
| 343 | /u/utility_room 1 | utility room |
| 344 | /v/valley 2 | valley |
| 345 | /v/vegetable_garden 2 | vegetable garden |
| 346 | /v/veterinarians_office 1 | veterinarians office |
| 347 | /v/viaduct 2 | viaduct |
| 348 | /v/village 2 | village |
| 349 | /v/vineyard 2 | vineyard |
| 350 | /v/volcano 2 | volcano |
| 351 | /v/volleyball_court/outdoor 2 | volleyball court |
| 352 | /w/waiting_room 1 | waiting room |
| 353 | /w/water_park 2 | water park |
| 354 | /w/water_tower 2 | water tower |
| 355 | /w/waterfall 2 | waterfall |
| 356 | /w/watering_hole 2 | watering hole |
| 357 | /w/wave 2 | wave |
| 358 | /w/wet_bar 1 | wet bar |
| 359 | /w/wheat_field 2 | wheat field |
| 360 | /w/wind_farm 2 | wind farm |
| 361 | /w/windmill 2 | windmill |
| 362 | /y/yard 2 | yard |
| 363 | /y/youth_hostel 1 | youth hostel |
| 364 | /z/zen_garden 2 | Zen garden |

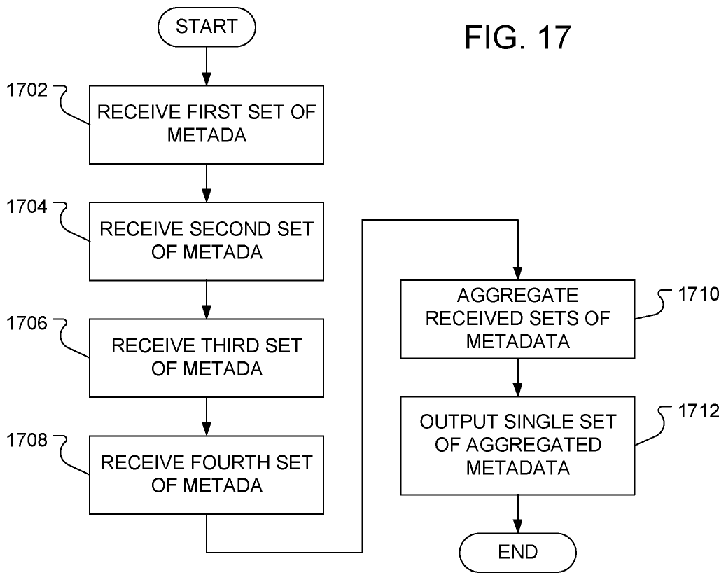

Referring to FIG. 17, an example method of video analysis metadata aggregation according to aspects of the present application is shown. The method may be performed by the video image analysis metadata aggregator 610, which receives (step 1702), from the human detection, tracking and recognition submodule 602, a first set of metadata associated, by the human detection, tracking and recognition submodule 602, with the video segment.

The video image analysis metadata aggregator 610 also receives (step 1704), from the audio analysis submodule 604, a second set of metadata associated, by the audio analysis submodule 604, with the video segment.

The video image analysis metadata aggregator 610 further receives (step 1706), from the human action recognition submodule 606, a third set of metadata associated, by the human action recognition submodule 606, with the video segment.

The video image analysis metadata aggregator 610 still further receives (step 1708), from the scene recognition submodule 608, a fourth set of metadata associated, by the scene recognition submodule 608, with the video segment.

The video image analysis metadata aggregator 610 then aggregates (step 1710) the received sets of metadata to a single set of aggregated metadata. Aggregating the metadata may involve simply combining the data from each of the first, second, third and fourth sets of metadata into a single larger set of metadata. In some examples, aggregating the metadata may involve removing any redundant data. The video analysis metadata aggregator 610 then outputs (step 1712) the video segment and the aggregated single set of metadata to the linkage discovery module 406. The aggregated single set of metadata may replace the first, second, third and fourth sets of metadata, or the first, second, third and fourth sets of metadata may be kept with the addition of the aggregated single set of metadata. In some examples, the video image analysis metadata aggregator 610 may also output the video segment that is associated with the aggregated single set of metadata. If the video segment is not outputted by the video image analysis metadata aggregator 610, the video image analysis metadata aggregator 610 may instead modify the video segment (e.g., by inserting the metadata or adding a tag to reference the metadata) to associate the video segment with the single set of aggregated metadata.

The example methods of FIGS. 13-17 are performed for each video segment outputted by the segmentor 600, until a set of aggregated metadata has been generated and associated with each video segment. The video segments may be reassembled back into a single video for subsequent linkage analysis (described further below), or may be kept as video segments. In the case where the video segments are reassembled back into a single video, there may be segmentation information added to indicate the start and end video images of each video segment within the video. The sets of aggregated metadata (which had been generated on the basis of respective video segments) may then be associated with the appropriate sequence of video images within the overall video.

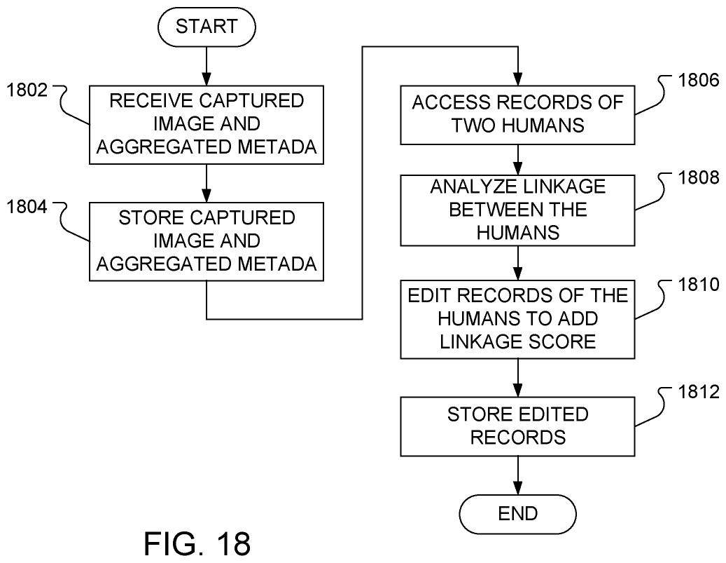

Referring to FIG. 18, an example method of linkage discovery according to aspects of the present application is shown. The method may be performed by the linkage analysis submodule 702 of the linkage discovery module 406 which receives (step 1802) the captured image (whether a static image or a set of video images) and the aggregated metadata from the static image analysis metadata aggregator 510 (if the captured image is a static image) or from the video image analysis metadata aggregator 610 (if the captured image is a video). As previously discussed, the aggregated metadata may include data including a human ID, associated human attribute data, associated location data and associated human activity data. For example, the record 900 in FIG. 9 illustrates the form and content of data that may be included in the aggregated metadata that is associated with the captured image. The linkage analysis submodule 702 stores (step 1804) the captured image and the associated aggregated metadata in the image collection human knowledge base 704.

The image collection human knowledge base 704 stores captured images and data about humans that have been recognized in the captured images. In some examples, data about the recognized humans may be stored in the form of records. A single record may include information about a single human (who may be uniquely identified in the image collection human knowledge base 704 by a human ID), including one or more attributes about the human, and one or more linkage scores representing the strength of a linkage between the identified human and another human. Further details are discussed below.

The linkage analysis submodule 702 accesses (step 1806) the records in the image collection human knowledge base 704 for a given pair of recognized humans in the captured image. The linkage analysis submodule 702 analyzes (step 1808) the metadata associated with the captured image to determine an extent to which the given pair of recognized humans are linked. As part of the analyzing (step 1808), the linkage analysis submodule 702 may assign a linkage score representative of a strength of a linkage between the two recognized humans. The linkage analysis submodule 702 then edits (step 1810) the records in the image collection human knowledge base 704 associated with the two recognized humans to add (or update) the linkage score. The linkage analysis submodule 702 then stores (step 1812) the edited records in the image collection human knowledge base 704.

One factor that may be used when establishing a linkage score for a linkage between two humans is the total number of times the two humans have co-occurred in captured images. The linkage between two humans may be considered to be stronger if the two humans co-occur in captured images more often than co-occurrence of two other humans in captured images.

Another factor that may be used when establishing a linkage score for a linkage between two humans is the total number of times the two humans co-occur in a given location. The linkage between two people may be considered to be stronger if the two humans co-occur in various locations more often than co-occurrence of two other humans in various locations.

In some examples, a linkage score may also be calculated between a human and a location. For example, a linkage score between a given human and a given location can be defined by counting the number of captured images where the given human appears in the given location.

The linkage analysis submodule 702 may determine a linkage score, between human i and human j, using the following equation:

$${l}_{ij} = \partial \cdot \frac{{N}_{ij}^{p}}{{N}_{i}^{p} + {N}_{j}^{p}} + β \cdot \frac{{N}_{ij}^{v}}{{N}_{i}^{v} + {N}_{j}^{v}} + γ \cdot \frac{{N}_{ij}^{L}}{{N}_{i}^{L} + {N}_{j}^{L}}$$

where Nᵢ^{p} is the number of photos having human i; Nⱼ^{p} is the number of photos having human j; Nᵢⱼ^{p} is the number of photos having both human i and human j; Nᵢ^{v} is the number of videos having human i; Nⱼ^{v} is the number of videos having human j; Nᵢⱼ^{v} is the number of videos having both human i and human j; Nᵢ^{L} is the number of locations where human i appears; Nⱼ^{L} is the number of locations where human j appears; and Nᵢⱼ^{L} is the number of locations where both human i and j appear.

The terms ∂, β and γ are weights that are configurable to balance relative impact, on the linkage score, lᵢⱼ, of photos, videos and locations. The weights may be manually configurable. Alternatively, the linkage analysis submodule 702 may learn the weights using a linear regression model on a labeled (e.g., manually label) training data set. An example linear regression model is known as a support-vector machine. In machine learning, support-vector machines (SVMs) are supervised learning models with associated learning algorithms that analyze data used for classification and regression analysis. During training, an associated learning algorithm of the SVM, given a set of training samples, each marked as belonging to one or the other of two categories, executes the associated learning algorithm and learns a model that assigns new samples to one category or to the other during inference.

A linkage score is one manner of describing a linkage between human i and human j. Another manner of describing such a linkage is a one-sentence diary entry. The diary entry may be generated, by the linkage analysis submodule 702, on the basis of captured documents in which both human i and human j have been detected. The diary entry can be generated, by the linkage analysis submodule 702, by filling in the missing information in a predefined human-to-human linkage template. A predefined human-to-human linkage template may have a format such as the following:
“[human 1] and [human 2] are attending [event] in [where] in [when].”

The linkage analysis submodule 702 may be configured to fill in the missing information in a predefined template based on the metadata received from the static image analysis metadata aggregator 510 and the video image analysis metadata aggregator 610 (depending on whether the captured image is a static image or a set of video images).

The linkage analysis submodule 702 may also be configured to generate an individual diary entry by filling in the missing information in a predefined human-to-location linkage template. A predefined human-to-location linkage template may have a format such as the following:
[human] is doing [what] in [where] in [when].

The information generated by the linkage analysis submodule 702 (e.g., the linkage score and/or the diary entry) may also be added to the metadata associated with the captured image.

Over time, the captured document analysis module 304 may process a plurality of captured image such that the image collection human knowledge base 704 is well populated with records of humans that have been detected in the captured images. Additionally, through the operation of the linkage analysis submodule 702, a human for whom there exists a record in the image collection human knowledge base 704 may be associated, by a linkage, with another human for whom there exists a record in the image collection human knowledge base 704. Subsequent to processing, by the linkage analysis submodule 702, both records in the image collection human knowledge base 704 will indicate that there is a linkage between the two humans and will include a linkage score indicative of a strength of the linkage.

The HCl module 302 may process the records in the image collection human knowledge base 704 to form a fluidly reconfigurable graphical representation of the contents of the image collection human knowledge base 704. The HCl module 302 may then control the display screen 104 of the electronic device 102 to render the graphical view.

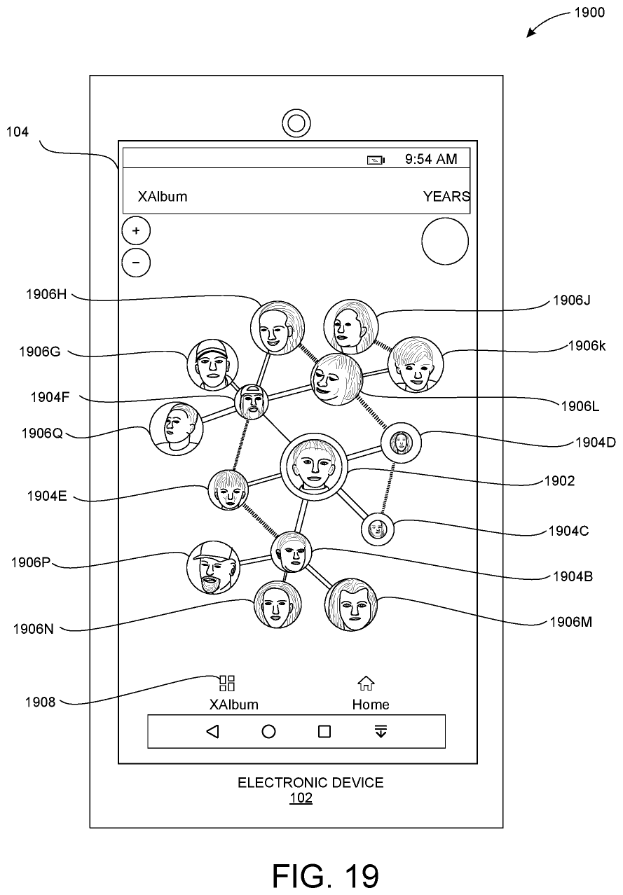

FIG. 19 illustrates an example view 1900 of a graphical user interface (GUI) rendered, according to aspects of the present application, on the display screen 104 of the electronic device 102. The example view 1900 comprises a plurality of representations. Each representation may be representative of a human with a corresponding record in the image collection human knowledge base 704. Additionally, each representation may be contained within a shape. In the example view 1900 of FIG. 19, the shape is a circle even though, of course, other shapes are possible. The example view 1900 includes a central representation 1902, a plurality of related representations 1904B, 1904C, 1904D, 1904E, 1904F (collectively or individually 1904) and a plurality of peripheral representations 1906G, 1906H, 1906J, 1906K, 1906L, 1906M, 1906N, 1906P, 1906Q (collectively or individually 1906). The related representations 1904 are each illustrated as having a direct connection to the central representation 1902. The peripheral representations 1906 are each illustrated as having a direct connection to at least one of the plurality of related representations 1904, while not being directly connected to the central representation 1902.

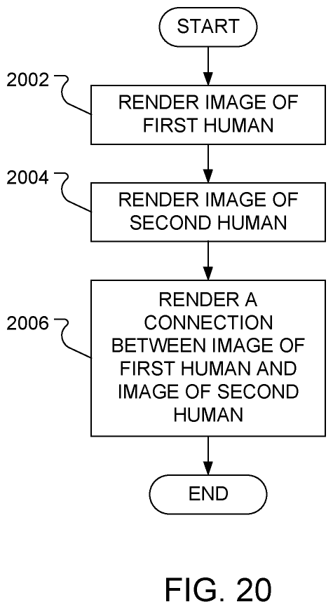

FIG. 20 illustrates example steps in a simplified method for rendering the example view 1900 of FIG. 19 according to aspects of the present application. The HCl module 302 accesses a record for a first human in the image collection human knowledge base 704 and controls the display screen 104 to render (step 2002) a GUI comprising the graphical view 1900 including a representation (e.g., a photograph) of the first human, e.g., the central representation 1902. The step 2002 may be performed in response to input selecting the first human as a human of interest (e.g., in response to user input). In some examples, the first human may be selected for the central representation 1902 by default, for example on the basis that the first human has been identified as the user of the electronic device 102 or on the basis that the first human appears the most among the captured images in the image collection human knowledge base 704.

The HCl module 302 then accesses a record for a second human in the album human knowledge base 704 and controls the display screen 104 to render (step 2004) a GUI comprising the graphical view 1900 of the album including a representation (e.g., a photograph) of the second human, e.g., the related image 19046. The HCl module 302 may select the second human on the basis of a linkage score contained in the record for the first human. For example, the HCl module 302 may select, for the second human, among those humans with whom the first human has a positive linkage score.

The HCl module 302 controls the display screen 104 to render (step 2006) in the example view 1900 a connection between the representation of the first human and the representation of the second human. That is, the HCl module 302 then controls the display screen 104 to render (step 2006) a connection between the central representation 1902 and the related representation 1904B.

The HCl module 302 may control the display screen 104 to render (step 2006) the connection in a manner that provides a general representation of the linkage score that has been determined between the humans represented by the two representations. For example, the HCl module 302 may control the display screen 104 to present render (step 2006) a relatively thick line connecting representations of two humans associated, in their respective records, with a relatively high linkage score between each other. Furthermore, the HCl module 302 may control the display screen 104 to render a relatively thin line connecting the representations of two humans associated, in their respective records, with a relatively low linkage score between each other.

Notably, the central representation 1902, the related representations 1904 and the peripheral representations 1906 may be rendered in a variety of sizes of representations. The size of the representation may be representative of a prevalence of the human associated with the representation within the image collection human knowledge base 704. That is, the HCl module 302 may render in the GUI a relatively large representation associated with a human detected in a relatively high number of captured images represented in the image collection human knowledge base 704. It follows that the HCl module 302 may render in the GUI a relatively small representation associated with a human detected in a relatively low number of captured images represented in the image collection human knowledge base 704.

It is well-established that the display screen 104 of the electronic device 102 may be touch-sensitive display screen and, a user may interact with the electronic device 102 using the display screen 104.

In one aspect of the present application, the user may interact with the example view 1900 to change the focus of the example view 1900. For example, responsive to the user tapping on the related representation 1904C, the HCl module 302 may modify the example view 1900 may self-adjust so that the related representation 1904B becomes the central representation 1902 of an altered example view (not shown). The HCl module 302 may further modify the example view to adjust the relationship of the representations to the newly altered central representation. In the altered example view, the formerly central representation 1902 and the formerly peripheral representations 1906M, 1906N, 1906P will become related representations. Additionally, in the altered example view, the related representations 1904C, 1904D and 1904F will become peripheral representations.

In another aspect of the present application, the user may interact with the example view 1900 to filter the captured images in the image collection human knowledge base 704. For example, the user may wish to review captured image in which have been detected the humans associated with the central representation 1902 and two of the related representations 1904C, 1904D.

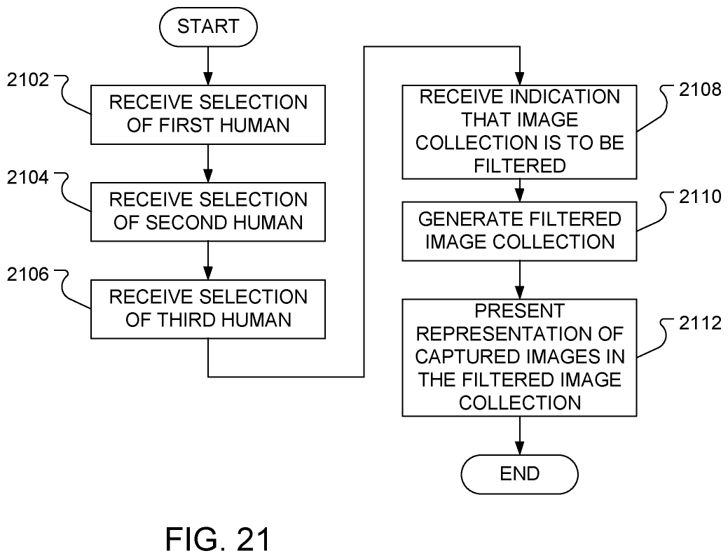

FIG. 21 illustrates example steps in a method of filtering the image collection human knowledge base 704 according to aspects of the present application. The user may provide input (e.g., interact with the display screen 104 if the display screen 104 is a touch-sensitive display screen) such that the HCl image 302 receives input indicating a selection of the three representations (step 2102, step 2104 and step 2106). To provide the input, the user may, for example, tap the display screen 104 in the vicinity of the three representations. Responsive to the input, the HCl module 302 may provide feedback to the user to illustrate that the representations have been selected. The feedback may take the form of a colored ring around the selected representations. The HCl module 302 may subsequently receive (step 2108) an indication that the image collection human knowledge base 704 is to be filtered on the basis of the selections. For example, to provide the indication, the user may select an album option 1908 to switch from the example view 1900 to a more traditional table and cell style view.

The HCl module 302 may determine the human IDs corresponding to the selected representations, and may filter the image collection human knowledge base 704 to generate (step 2110) a filtered image collection that includes only the captured images having metadata that includes all three human IDs (that is, only captured images in which all three selected humans have been recognized). For example, the HCl module 302 may query the image collection human knowledge base 704 to identify all captured images associated with metadata that includes all three human IDs, and generate the filtered image collection using those identified captured images. The HCl module 302 may render (step 2112) the table and cell style view such that only representations of captured images in the filtered image collection are shown. That is, the table and cell style view only provides access to a filtered set of captured images.

The user may then provide input to select a particular captured image, among the filtered set of captured images. Responsive to the input selecting the particular captured image, the HCl module 302 may display the captured image in a manner that takes up a majority of the display screen 104.

In the case wherein the particular captured image is a video, the selected three humans may be detected in only a particular video segment. That is, the metadata for only a particular video segment within the video includes all three human IDs. The HCl module 302 may, rather than presenting the entirety of the video from the first video image, instead present only that particular video segment where the three selected people have been detected. Alternatively, the HCl module 302 may present the entire video, but automatically play the video starting from the first frame of the particular video segment (instead of the first frame of the entire video).

As presented in FIG. 19, the example view 1900 may be representative of linkages between humans, as determined for the entirety of the image collection human knowledge base 704. It is contemplated that the example view 1900 may be configured in different ways. For one example, the example view 1900 may be configured to only relate to a specific time period (which may be defined based on user input), say, the year 2018. For another example, the example view 1900 may be configured to only relate to a specific geographic place (which may be defined based on user input). Combinations may also be possible (e.g., the example view 1900 may be configured to related to a specific time period in a specific geographic place).

In this way, the present application provides a way to enable a user to more quickly browse a large collection of captured images, discover relationships between humans in the captured images, learn the activities of the humans and/or more effectively search captured images featuring particular humans of interest.

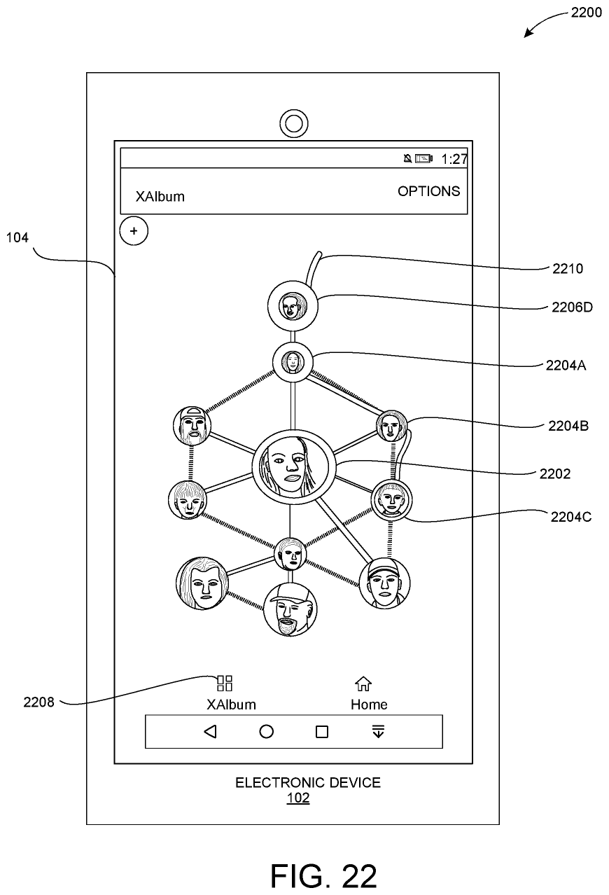

FIG. 22 illustrates an example view 2200 of a GUI rendered, according to aspects of the present application, on the display screen 104 of the electronic device 102 of FIG. 1 with an indication of a path for a touch gesture. The example view 2200 comprises a plurality of representations. Each representation may be representative of a human with a corresponding record in the image collection human knowledge base 704. The example view 2200 includes a central representation 2202, a plurality of related representations 2204A, 2204B, 2204C (collectively or individually 2204) and a plurality of peripheral representations, with only one peripheral representation being associated with a reference numeral, 2206D. The related representations 2204 are each illustrated as having a direct connection to the central representation 2202. The peripheral representations 2206 are each illustrated as having a direct connection to at least one of the plurality of related representations 2204, while not being directly connected to the central representation 2202.

Unique to the example view 2200 of FIG. 22 is a trace 2210 illustrating a path taken by a touch interaction with the display screen 104. In response to the touch interaction represented by the trace 2210, the HCl module 302 may detect selection of the four representations (2206D, 2204A, 2204B, 2204C) through which the trace 2210 passes. For example, the touch-sensitive display screen may generate data representing areas of the screen 104 traversed by the touch interaction. The HCl module 302 may identify, from the data generated by the touch-sensitive display screen, the representations that coincide with the path of the touch interaction. Responsive to receiving the touch interaction represented by the trace 2210, the HCl module 302 may provide feedback to the user to illustrate that the representations have been selected. The feedback may take the form of a colored ring around the representations. The HCl module 302 may subsequently receive an indication that the image collection human knowledge base 704 is to be filtered on the basis of the selections. For example, to provide the indication, the user may select an album option 2208 to switch from the example view 2200 to a more traditional table and cell style view.

The HCl module 302 may filter the image collection human knowledge base 704 to generate a filtered image collection that includes only the captured images in which all four people have been detected, for example as discussed above in detail. The HCl module 302 may render the table and cell style view such that only representations of captured images in the filtered image collection are shown. That is, the table and cell style view only provides access to a filtered set of captured images.

The user may then select a particular captured image, among the filtered set of captured images. Responsive to the selecting of a particular captured image, the captured image may be displayed in a manner that takes up a majority of the display screen 104.

The present application has described example methods and systems to enable management of images in an image collection on a human-centric basis. The examples described herein, enable automatic identification of linkages between humans in captured images, and generates data (e.g., linkage scores) to enable management of the captured images on the basis of the strength of human-centric linkages.

In some examples, the present application provides improvements for managing and searching a large number of images, on the basis of human-centric linkages. A more effective way is provided for navigating through the large number of images in the image collection.

In some examples, the present application describes methods for generating diary entries that provide information about human activities in captured images, including human-to-human activities as well as human-to-location activities.

Although the present disclosure describes functions performed by certain components and physical entities, it should be understood that, in a distributed system, some or all of the processes may be distributed among multiple components and entities, and multiple instances of the processes may be carried out over the distributed system.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A system comprising:
a memory including an image collection database, the image collection database storing a plurality of videos;
a processor coupled to the memory, the processor configured to execute instructions to cause the system to:
receive a new image that is not in the image collection database, the new image being associated with a set of metadata identifying at least an identified location in the new image;
generate a first location linkage score associating a first identified human with the identified location, the first location linkage score representing a number of times that the first identified human appears in the identified location in the image collection database;
generate a second location linkage score associating a second identified human with the identified location, the second location linkage score representing a number of times that the second identified human appears in the identified location in the image collection database;
generate a relationship linkage score between the first identified human and the second identified human, based on at least the first location linkage score and the second location linkage score;
update respective records in the image collection database associated with the first and second identified humans to store at least the generated relationship linkage score;
store the metadata, in association with the new image, in the image collection database; and
render a graphical user interface (GUI) for interacting with the image collection database, the GUI being rendered to provide an album including a representation of at least the first identified human or the second identified human, based on at least the stored relationship linkage score.

2. The system of claim 1, wherein the processor is further configured to execute instructions to cause the system to:
identify each human in the new image;
determine an identifier for each identified human; and
generate metadata for inclusion in the set of metadata associated with the new image, the generated metadata including the identifier for each identified human.

3. The system of claim 1, wherein the processor is further configured to execute instructions to cause the system to:
generate an entry comprising a sentence describing the first identified human or the second identified human in the identified location, the sentence being generated by using the set of metadata to populate a template; and
store the entry in the image collection database.

4. The system of claim 1, wherein the new image is a captured video comprising a plurality of video segments, and wherein there are multiple sets of metadata associated with the captured video, each set of metadata being associated with a respective video segment of the captured video, and wherein the processor is further configured to execute instructions to cause the system to generate the first location linkage score, the second location linkage score and the relationship linkage score for each respective video segment; and wherein the captured video is stored in the image collection database in association with the multiple sets of metadata.

5. (canceled)

6. The system of claim 1, wherein the processor is further configured to execute instructions to cause the system to:
render the GUI to provide a visual representation of the relationship linkage score between the first and second identified humans.

7. The system of claim 6, wherein the processor is further configured to execute instructions to cause the system to:
in response to input, received via the GUI, indicating a selection of the representation of at least the first or second identified humans for filtering the image collection database, identify, from the image collection database, one or more images associated with metadata that includes identifiers for at least the first or second identified humans; and
provide commands to render the GUI to limit access to only the identified images.

8. The system of claim 7, wherein the input received via the GUI is a touch input that traverses the representation of the first or second identified humans.

9. A method of managing an image collection database storing a plurality of videos, the method comprising:
receiving a new image that is not in the image collection database, the new image being associated with a set of metadata identifying at least an identified location in the new image;
generating a first location linkage score associating a first identified human with the identified location, the first location linkage score representing a number of times that the first identified human appears in the identified location in the image collection database;
generating a second location linkage score associating a second identified human with the identified location, the second location linkage score representing a number of times that the second identified human appears in the identified location in the image collection database;
generating a relationship linkage score between the first identified human and the second identified human, based on at least the first location linkage score and the second location linkage score;
updating respective records in the image collection database associated with the first and second identified humans to include store at least the generated relationship linkage score;
storing the metadata, in association with the new image, in the image collection database; and
rendering a graphical user interface (GUI) for interacting with the image collection database, the GUI being rendered to provide an album including a representation of at least the first identified human or the second identified human, based on at least the stored relationship linkage score.

10. The method of claim 9, further comprising:
identifying each human in the new image;
determining an identifier for each identified human; and
generating metadata for inclusion in the set of metadata associated with the new image, the generated metadata including the identifier for each identified human.

11. The method of claim 9, further comprising:
generating an entry describing the first identified human or the second identified human in the identified location; and
storing the entry in the image collection database.

12. The method of claim 9, wherein the new image is a captured video comprising a plurality of video segments, and wherein there are multiple sets of metadata associated with the captured video, each set of metadata being associated with a respective video segment of the captured video, the method further comprising: generating the first location linkage score, the second location linkage score and the relationship linkage score for each respective video segment; and wherein the captured video is stored in the image collection database in association with the multiple sets of metadata.

13. (canceled)

14. The method of claim 9, further comprising:
render the GUI to provide a visual representation of the relationship linkage score between the first and second identified humans, and including a connector between the representative images representations of the first and the second identified humans, the connector having a thickness according to the relationship linkage score between the first and second identified humans.

15. The method of claim 14, further comprising:
in response to input, received via the GUI, indicating a selection of the representation of at least the first or second identified humans for filtering the image collection database, identifying, from the image collection database, one or more images associated with metadata that includes identifiers for at least the first or second identified humans; and
providing commands to render the GUI to limit access to only the identified images.

16. The method of claim 15, wherein the input received via the GUI is a touch input that traverses the representation of the first or second identified humans.

17-20. (canceled)

21. The system of claim 1, wherein the system is one of an electronic device, a server, and a cloud computing platform.

22. The system of claim 1, wherein the processor is further configured to execute instructions to cause the system to:
analyze an audio track associated with the new image to identify a type of sound in the audio track; and
generate metadata for inclusion in the set of metadata associated with the new image, the generated metadata including a label representing the type of sound in the audio track.

23. The system of claim 6, wherein the visual representation includes a connector between the representations of the first and the second identified humans, the connector having a thickness according to the relationship linkage score between the first and second identified humans.

24. The system of claim 6, wherein the processor is further configured to execute instructions to cause the system to:
provide commands to render the GUI to represent respective relationship linkage scores between the first identified human and other related identified humans identified in metadata of other images stored in the image collection database;
wherein the representation of the first identified human is rendered at a central position in the GUI, wherein representations of the related identified humans rendered about the representation of the first identified human, each representation of the related identified humans being visually connected to the representation of the first identified human with a connector according to the respective relationship linkage score; and
wherein a representation of a peripheral identified human having a relationship with a given related identified human is rendered with a connector to the given related identified human, and without a connector to the first identified human.

25. (canceled)

26. (canceled)
